(19) United States
(12) Patent Application Publication
(10) Pub. No.: US 2018/0265417 A1
(43) Pub. Date: Sep. 20, 2018

(54) SUSCEPTOR MATERIALS FOR 3D PRINTING USING MICROWAVE PROCESSING

(71) Applicant: Hewlett-Packard Development Company, L.P., Houston, TX (US)

(72) Inventors: David A Champion, Lebanon, OR (US); James Elmer Abbott, JR., Albany, OR (US)

(21) Appl. No.: 15/542,624

(22) PCT Filed: Jan. 23, 2015
(86) PCT No.: PCT/US2015/012612

§ 371 Date: Jul. 10, 2017

(51) Int. Cl. C04B 35/626; C04B 35/505; C04B 35/111; C04B 35/565; C04B 35/628; H05B 6/64

(52) U.S. Cl. CPC C04B 35/62655; C04B 35/505; C04B 35/111; H05B 6/64; C04B 35/62813; C04B 35/62815; C04B 35/62839; C04B 35/565

(57) ABSTRACT

A 3D printing system includes a build material and an ink for patterning portions of the build material. The printing system further includes two or more susceptors, a first susceptor and a second susceptor. The first susceptor causes heating when exposed to microwave radiation at a first temperature. The second susceptor causes heating when exposed to microwave radiation at a second temperature. The first susceptor material is decomposable or oxidizable at a third temperature that is higher than the second temperature. The second susceptor is transparent to microwave radiation at the first temperature.

### BACKGROUND

Many ceramic materials are transparent to microwaves at room temperature. Most ceramics have a temperature above which they will efficiently absorb microwaves and undergo the required heating for sintering. To heat these materials in a microwave field, a susceptor material may be added to the ceramic mixture to enable efficient heating even at low initial temperatures. For some materials, the best materials properties can only be achieved if no susceptor material is present in the final part. Thus, the susceptor may be present at low initial temperature but removed from the ceramic matrix in the final part.

Additive manufacturing (AM), also known as 3D printing, may be used to make a three-dimensional object of almost any shape from a 3D model or other electronic data source primarily through additive processes in which successive layers of material are laid down. The properties of the three-dimensional object may vary depending on the materials used as well as the type of additive manufacturing technology implemented.

3D-printing, along with other additive manufacturing and rapid prototyping (RP) techniques, involves building up structures in a layer by layer fashion based upon a computer design file. Such techniques are well suited to the production of one-off, complex structures that would often be difficult to produce using traditional manufacturing methods. There have been both rapid growth and interest in this field during recent years and a range of techniques is now available which make use of many common materials such as plastic, metal, wood, and ceramic.

### BRIEF DESCRIPTION OF THE DRAWINGS

FIG. 1 is a plot, on coordinates of temperature as a function of time, for a two-susceptor system of carbon-alumina, according to an example.

FIG. 2 is a plot, on coordinates of temperature as a function of time, for a three-susceptor system of water-carbon-alumina, according to an example.

FIG. 3 is a process chart, depicting a method of manufacturing a three-dimensional object, according to an example.

### DETAILED DESCRIPTION

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

While a limited number of examples have been disclosed, it should be understood that there are numerous modifications and variations therefrom. Similar or equal elements in the Figures may be indicated using the same numeral.

It is be noted that, as used in this specification and the appended claims, the singular forms “a,” “an,” and “the” include plural referents unless the context clearly dictates otherwise.

As used herein, the term “about” is used to provide flexibility to a numerical range endpoint by providing that a given value may be “a little above” or “a little below” the endpoint, and may be related to manufacturing tolerances. The degree of flexibility of this term can be dictated by the particular variable and would be within the knowledge of those skilled in the art to determine based on experience and the associated description herein. In some examples, “about” may refer to a difference of ±10%.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or subranges encompassed within that range as if each numerical value and subrange is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1 to 3, from 2 to 4, and from 3 to 5, etc. This same principle applies to ranges reciting only one numerical value. Furthermore, such an interpretation should apply regardless of the breadth of the range or the characteristics being described.

Additive manufacturing techniques may generate a three-dimensional object through the solidification of a loose or liquid build material. The properties of fabricated objects are dependent on the type of build material and the type of solidification mechanism used.

In some examples, the build material is powder-based. A chemical binder or radiation-responsive coalescing agent is deposited into a layer of powered build material to form one layer of the object. Another type of additive manufacturing uses laser sintering. In this process, a laser is applied to heat the build material. The laser used is precise, but may be costly to purchase and maintain. Another type of additive manufacturing involves extruding the build material onto a surface in the form of a layer of the object being fabricated. The deposited material is subsequently heated to sinter that build material. This process may be relatively cost effective, but poor resolution of the final product may render the product incompatible with some applications where a more precise product is needed.

The present specification describes a method of fabricating a three-dimensional object by depositing a layer of build material and depositing an ink onto the layer of build material according to a slice of three-dimensional model data. This process is repeated, layer-by-layer, until the object is complete. The object, which may still be in powder bed containing the build material, is then irradiated with microwave radiation, such as in a microwave furnace. The ink may contain a first susceptor material that absorbs microwave radiation at room temperature, while the build material may contain a second susceptor material that does not significantly absorb microwave radiation at lower temperatures but does absorb microwave radiation at a higher temperature, called the critical temperature. The second susceptor continues to heat the object to sinter it and to remove the first susceptor, either by decomposition or oxidation. Once the process is complete, the sintered object may be removed from the microwave furnace. As noted elsewhere, the second susceptor need not be in the build material, but instead may also be in the ink.

The present specification also describes a ceramic-based 3D printing system including the build material and an ink for patterning portions of the build material. The printing system includes two or more susceptors, having the properties described above.

As used in the present specification and in the appended claims, a susceptor is a material used for its ability to absorb electromagnetic energy and convert it to heat (which is sometimes designed to be re-emitted as infrared thermal radiation). This energy is typically microwave radiation used in industrial heating processes. The name is derived from susceptance, an electrical property of materials that measures their tendency to convert electromagnetic energy to heat.

Further, as used in the present specification and in the appended claims, the term “build material” means a loose or fluid material, for example, a powder, from which a desired three-dimensional object is formed in additive manufacturing. However, it is appreciated that while the build material is described herein in terms of powder, other forms of the build material may also be used, such as, but not limited to, ceramic slurry, slip material for slip casting, reactive liquid, Sol Gel deposited material, etc. may also be used to deposit the build material.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

Many ceramic materials, as well as glasses, are relatively transparent to microwaves at room temperature. Most ceramics and glasses have a temperature above which they will efficiently absorb microwaves and undergo the required heating for sintering. However, to heat these materials in a microwave field, a susceptor material may be added to enable efficient heating even at low initial temperatures, such as room temperature. For some ceramic and glass materials, the best materials properties can only be achieved if no susceptor material is present in the final part. Thus, the susceptor may be present at low initial temperature and removed from the build material or changed in the final part.

In accordance with the teachings herein, a 3D printing system may include a build material and an ink for patterning portions of the build material. The printing system may further include two or more susceptors, a first susceptor that causes heating when exposed to microwave radiation at a first temperature and a second susceptor that causes heating when exposed to microwave radiation at a second temperature. The first susceptor material may be decomposable or oxidizable at a third temperature that is higher than the second temperature. The second susceptor typically absorbs no or minimal microwave radiation at the first temperature.

In some examples, the first susceptor may be part of the ink, while the second susceptor may be part of the build material. In other examples, the second susceptor may also be part of the ink. For example, glass and Al₂O₃ nano particles, both of which are second susceptors, and Fe₃O₄-based materials, which is a first susceptor, may each be part of the ink and printed into the build material.

The first susceptor material may absorb microwave radiation at room temperature. The second susceptor material may be relatively transparent to microwave radiation at lower temperatures but may absorb microwave radiation at a second, higher temperature. The first susceptor material may be decomposable or oxidizable at a third temperature that is higher than the second temperature. As used herein, room temperature is taken to be about 20 to 26° C.

The first susceptor material may be carbon or semiconductor material. These susceptors readily absorb microwave radiation at room temperature. Examples of sources of carbon may include, but are not limited to, carbon nanotubes (CNTs), carbon black, graphite, graphene, fullerenes, silicon carbide (SiC), and hydrocarbons containing a polar group such as fatty acids, vegetable oil, and the like.

In some examples, the first susceptor may be vitreous carbon. Vitreous carbon is also known as alpha or glassy carbon. Carbon burns out as a CO or CO₂ product in the presence of oxygen at sufficiently high temperatures.

Other first susceptors of interest include materials that transform to a low absorption material at room temperature. For example, highly microwave absorbing silicon converts to low absorbing SiO₂. Likewise, germanium, which is highly microwave absorbing, converts to low absorbing GeO₂.

Metal nano particles, such as silver, aluminum, copper, and tin, may also be employed as first susceptors in the practice of these teachings. Such metal nano particles may be relatively highly microwave absorbing, but their oxides are comparatively transparent to microwave radiation, at least at room temperature. By the term “nano particles” is meant particles having a dimension on the order of 1 nm to 10 μm, depending primarily on the conductivity of the metal. In general, the higher the resistivity, the larger the particle can be before it begins to significantly reflect microwaves instead of absorbing them. The nano particles may be spherical, ellipsoidal, or other shape.

Reduced metal oxides, in which the fully oxidized oxide is less absorbing than the oxygen-poor version, may also be employed as first susceptors in the practice of these teachings. For example, TiOₓ, where x is less than 2, is relatively highly microwave absorbing at room temperature. Upon oxidation to TiO₂, the fully oxidized oxide has a lower absorption ability at room temperature. Other reduced oxides may also be employed; such examples may include ferrite (Fe₃O₄), TaOₓ, NbOₓ, WOₓ, VOₓ, ZrOₓ, HfOₓ, MoOₓ, CuOₓ, SnOₓ, ZnOₓ, and CoOₓ, and other oxides in which the reduced oxide exhibits metallic or semiconducting behavior, where x is less than the stoichiometric value.

The first susceptor may be included in an ink used to print the pattern in the build material. The ink composition may be made of
about 1 to 35 wt % first susceptor;
about 1 to 20 wt % filler; and
balance liquid vehicle.

The filler may serve two purposes: (1) to fill in pore structures in the build powder and thereby create a higher density part, and (2) to lower the melting point and help drive reactive sintering by reducing the sintering temperature. Examples of fillers may include SiO₂, nano particle Al₂O₃, or other ceramic or glass, which may be the same as or different than the ceramic and/or glass employed in the build material.

The liquid vehicle may be water or low molecular weight organic co-solvent commonly used in inkjet printing.

The second susceptor may be a ceramic, such as alumina (Al₂O₃), yttria (Y₂O₃), silica (SiO₂), silicon nitride (Si₃Ni₄), boron nitride (BN), spinel (MgO.Al₂O₃), fluorite (CaF₂), titania (TiO₂), zirconia (ZrO₂), barium titanate (Ba—TiO₃), hydroxyapatite, calcium oxide, phosphorus oxide, or sodium oxide. The second susceptor may also be a fully oxidized version of the reduced oxides, namely, Ta₂O₅, Nb₂O₅, WO₃, VO₂, HfO₂ MoO₃, CuO, SnO₂, ZnO, or CoO. Upon microwave heating to an elevated temperature, using the first susceptor, the second susceptor begins to absorb microwave radiation and continues the heating process, both to sinter the object and to remove the first susceptor, such as by decomposition or oxidation.

As an example, there are materials, such as hydroxyapatite, that absorb microwave energy, but not as strongly as carbon or certain other susceptor materials. In this case, carbon can be used as the first susceptor, and hydroxyapatite may act as both a build layer and a second susceptor.

As another example, consider the silicon carbide-alumina system. SiC may be used as a microwave susceptor to heat Al₂O₃ to about 500° C., which is approximately its critical temperature. Above about 500° C., the microwave radiation will couple directly to the Al₂O₃ and heat it.

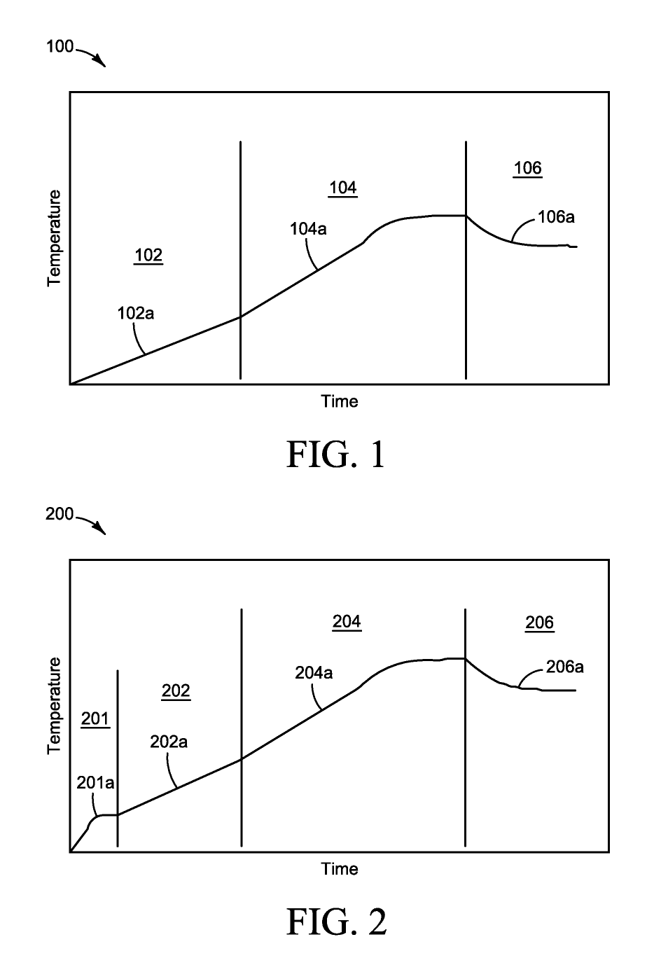

One example of susceptor behavior is depicted in FIG. 1, which is a plot 100 of temperature as a function of time for a carbon-alumina system. In this system, carbon absorbs microwaves at room temperature, while alumna is transparent to microwaves. Alumina begins absorbing microwave radiation at about 500° C.

As shown in region 102, curve 102a depicts an initial heating rate due to the presence of carbon. In region 104, curve 104a depicts a new initial heating rate due to both carbon and alumina once the combination has passed 500° C. and the alumina has started self-heating, assuming no thermal runaway for alumina. Thermal runaway means that the heating rate increases drastically and melts the sample. In region 106, curve 106a depicts burn-out of carbon, with further heating only by alumina above its critical temperature. In this manner, the first susceptor, carbon, is removed, leaving only the alumina.

FIG. 2 depicts an example of susceptor behavior with loss of the susceptor below the sintering temperature. In this case, a third susceptor may be employed, namely, water. FIG. 2 is a plot 200 of temperature as a function of time for a water-carbon-alumina system. Again, in this system, carbon absorbs microwaves at room temperature, while alumna is transparent to microwaves. In this example, water may be added to the system and may provide some initial heating with carbon. Water then evaporates, resulting in a rapid increase in temperature due to only carbon until reaching the critical temperature of the alumina.

As shown in region 201, curve 201a depicts an initial heating rate due to the presence of water and the carbon susceptor. As shown in region 202, curve 202a depicts a heating rate due to the presence of carbon after the water evaporates. In region 204, curve 204a, like curve 104a, depicts a new initial heating rate due to both carbon and alumina once the combination has passed 500° C. and the alumina has started self-heating, assuming no thermal runaway for alumina. In region 206, curve 206a depicts burn-out of carbon, with further heating only by alumina above its critical temperature. In this manner, the first susceptor, carbon, is removed, leaving only the alumina.

The combination of build material and ink, once the object has been printed in the build material, may be dried, to evaporate the liquid vehicle of the ink, prior to subjecting to microwave radiation and sintering. Alternatively, the object may be placed directly into the microwave furnace, where the liquid vehicle may serve as the third susceptor, as shown in FIG. 2. This may be particularly useful for assisting some first susceptors, such as ferrite.

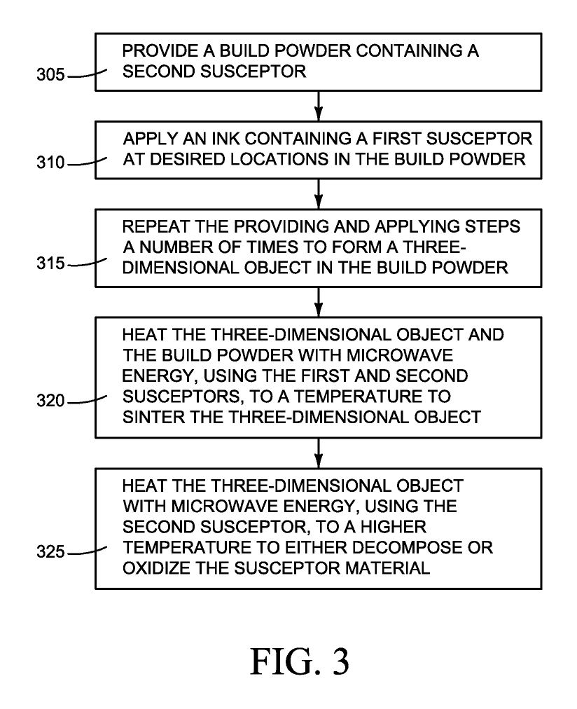

In an example process 300, depicted in FIG. 3, a build powder may be provided 305. The build powder may be any of the glass frits or ceramic powders described above. The build powder may be formed of one or more glass frits, one or more ceramic powders, or a mixture. Any of the glass frits and/or ceramic powder may serve as the second susceptor.

An ink may be selectively applied 310 at desired locations in the build powder. This may be accomplished by providing a layer of the build powder, then printing the ink in the desired pattern in the build powder. The ink may include the first susceptor.

The process of providing a layer of the build powder and selectively applying the ink may be repeated 315 a number of times until the three-dimensional object is formed in the build powder.

The three-dimensional object and the build powder may be heated 320 with microwave radiation, using the first and second susceptors, to a temperature to sinter the three-dimensional object. As noted above, the first susceptor heats the object until the second susceptor reaches a sufficiently high temperature to take over the heating. The sintering temperature is the second temperature discussed above.

The three-dimensional object and the build powder may be further heated 325 with microwave radiation, using the second susceptor, to a higher temperature to either decompose or oxidize the susceptor material. This is the third temperature discussed above.

The patterned sample may subsequently be cooled to room temperature.

The foregoing procedure may be used to control the rate of heating and final temperature the part is held at.

The build material may be a mixture of at least one glass frit and at least one ceramic powder (the second susceptor). However, in some examples, the build material may be glass-based, where the second susceptor is provided in the ink along with the first susceptor. The build material may be uniformly spread over the area to be printed. This thin layer may be up to about a few mm thick. In some examples, the thin layer may be about 100 μm thick. A printhead may be used to jet drops of the ink containing the first susceptor (microwave radiation absorber which readily converts this energy to heat) onto/into the powder which is absorbed and dried very rapidly due to the desiccant properties of the ceramic powder.

The glass frit may be any of the common glasses, such as, but not limited to, soda-lime-silica glasses, aluminosilicate glasses, with or without alkali oxides, and borosilicate glasses. Both the glass frit and the ceramic powder may have a particle size of about 150 nm to about 100 μm. The particles may be spherical, random shape, or other suitable shape.

The composition of the build material may range from 100 wt % glass frit to 100 wt % ceramic powder and compositions in between, as glass frits, like ceramic powders, also tend to have minimal to no absorption of microwave radiation at lower temperatures and absorb at elevated temperatures.

The first susceptor has the property that it will decompose once a pre-selected thermal threshold has been achieved. For carbon-based susceptors, this temperature is about 500° to 600° C. in an oxygen-rich environment where CO or CO₂ is the end product. Other susceptor materials may oxidize at higher temperatures. The availability of different susceptors provides a reasonable range of options to handle fairly complex systems. By printing ink containing the susceptor material, the concentration can be controlled to provide substantially uniform heating and to permit removal from the final part through an oxidation or decomposition or similar chemical reaction. Once the pattern is complete for that layer, another layer of ceramic powder is spread over the entire area and the printing process resumes. The structures are printed in this way, layer by layer, in the bed of ceramic powder. Once the structure has been fully printed, the entire powder bed is conveyed to a microwave furnace where the ceramic powder is sintered only where susceptor ink has been printed.

The materials for making 3D parts may include the build material (glass frit and/or the ceramic powder), which may include the second susceptor, and the ink, which may include the first susceptor. The build material is what the 3D parts may be made of, while the ink is used to print the 3D part, layer by layer, using a delivery system.

The ink may be delivered onto the build material by a delivery system such as thermal inkjet or piezoelectric inkjet or other such technologies.

### EXAMPLES

### Example 1

A first susceptor material was chosen to absorb microwaves, and heating the sample was begun at room temperature. The first susceptor was carbon-based. This material was selectively deposited into a first layer of build material in an ink. Here, the build material was a mixture of soda-lime-silica based glass frit (about 20 wt %) mixed with a high purity alumina ceramic powder (about 80 wt %). An ink containing 4 to 5 wt % of carbon black was selectively deposited onto the build material using thermal ink jet technology. After the first layer of powder was selectively deposited with the carbon-based susceptor material, a subsequent layer of powder was deposited and then selectively deposited with carbon from the ink. This process was repeated until the basic structure of a three-dimensional object was defined in the powder bed.

In this example, the powder bed was then removed from the printer, allowed to dry at an elevated temperature, such as approximately 100° to 150° C., for a period of time, such as one hour, and then placed into a microwave furnace with air atmosphere for selective sintering of the glass—ceramic mixture. When exposed to the microwave radiation, the sample selectively heated in the areas defined by the carbon susceptor material. This heating went to approximately 200° C., where the glass frit began to absorb microwaves, thereby leading to an increased heating rate. The part continued to rise in temperature to greater than 500°C. where the alumina also began to heat significantly in the microwave radiation. Also, above 500°C., the carbon began to oxidize rapidly, leading to a decrease in heating rate due to carbon. This decrease in heating rate due to carbon may have improved the overall control of the system by decreasing the risk of thermal runaway. The glass frit began to flow slightly around 570°C., thereby beginning the process of part densification and associated shrinkage. Energy continued to be applied to greater than 800° C., which allowed significant densification of the glass—alumina composite. The part was held at temperature for approximately 5 minutes for a small part and more for a larger part; and then application of microwave radiation was terminated. The small part was allowed to cool in the furnace for about 5 minutes and then removed to finalize cooling at room temperature. When the part was removed from the powder bed, it was white because the carbon had been largely removed, leaving a white color from the frit and the alumina. The part faithfully represented the pattern defined by the original selectively-deposited carbon material.

### Example 2

In some situations, it may be desirable to preheat the powder bed using a small amount of water in the build layer. For this example, a water-based ink containing carbon was selectively deposited into a build layer of 20 wt % glass frit and 80 wt % alumina powder. The part was defined by selectively patterning successive layers with the water and carbon ink. The ink containing 4 to 5 wt % of carbon black was selectively deposited onto the build material using thermal ink jet technology. When the part was fully defined, the powder bed was transferred to a microwave furnace for heating and final fusing of the defined part. The part was then exposed to microwave radiation of about 400 watts for 2 to 5 minutes to preheat the part before final firing was completed. The heating was due to microwave absorption by both the water and carbon present in the part. At the end of this initial heating cycle, the part was heated to a relatively uniform temperature between 100° C. to 200°C., regulated by the evaporation of the water from the part. Before sintering, it was essential to remove all water to ensure no bubbles were formed in the final structure due to subsequent evaporation. This process also caused a partial degas of the defined part, further reducing the risk of bubble formation in the final part. Once the preheat stage was complete, the part was exposed to the appropriate power sequence to drive the part to the temperatures required for final fusing of the part. As with the Example 1, carbon provided the only significant microwave absorption until the glass was heated above a critical point (above 200° C.) where both carbon and glass frit absorption of the microwaves enabled rapid heating to more than 500° C. As the alumina heated above 500°C., it began to absorb energy and cause heating at an appreciable level. Also above 500° C., the carbon began to oxidize rapidly, leading to a decrease in heating rate. This decrease in heating rate may have improved the overall control of the system by decreasing the risk of thermal runaway. The glass frit began to flow slightly around 570°C., beginning the process of part densification and associated shrinkage. Energy continued to be applied to greater than 800° C., allowing for significant densification of the glass—alumina composite. The part was held at temperature for approximately 5 minutes for a small part and more for a larger part; then, application of microwave radiation was terminated. The small part was allowed to cool in the furnace for about 5 minutes and then removed to finalize cooling at room temperature. When the part was removed from the powder bed, it was white because the carbon had been largely removed, leaving color from the frit and the alumina. The part faithfully represented the pattern defined by the original selectively-deposited carbon material.

### Example 3

In another example, an ink containing carbon material was selectively deposited into a powder bed of pure alumina. The ink containing 4 to 5 wt % of carbon black was selectively deposited onto the build. After patterning, the powder bed was then transported to a microwave furnace for final processing. In this case, initial heating was performed in a chemically-reducing forming gas environment to enable rapid heating to temperatures greater than 1000°C. due to the efficient microwave absorption of the carbon susceptor. At this temperature, the alumina also absorbed microwaves so air could be introduced to the system to burn out the carbon. This allowed for a reduced absorption rate of the microwaves and better ability to stabilize the temperature for a given part at high temperature. After holding the part at the sintering temperature to enable densification, the microwave radiation was turned off and the part was allowed to cool in the furnace. When the part was removed from the powder bed, it was white because the carbon has been largely removed, leaving a white color from the frit and the alumina. The part faithfully represented the pattern defined by the original selectively-deposited carbon material.

### Example 4

An ink containing carbon was selectively added to an alumina build material combined with trace amounts of iron oxide and silicon dioxide. The ink containing 8 to 10 wt % of carbon black was selectively deposited onto the build material. This was placed into a microwave furnace and exposed to microwave radiation. The part heated rapidly to between about 700 to 900° C., where the carbon burned out quickly. The alumina, iron oxide, and silicon dioxide were at a sufficient temperature that they absorbed a significant amount of microwave radiation. The heat lost by the part at this point in the build material and furnace that the temperature stopped rising at about 900° C. The part was held at temperature for about 10 minutes to maximize densification possible at this temperature. The microwave radiation was removed and the part allowed to cool. When the part was removed from the powder bed, it was black in color due to the iron oxide remaining. The part faithfully represented the pattern defined by the original selectively-deposited carbon material. In this case, the carbon burn out was used to set the final firing temperature of the part. If the carbon had been prevented from burning out, much higher temperatures would have been reached and thermal runaway may have occurred, leading to part distortion.

What is claimed is:

1. A 3D printing system including a build material and an ink for patterning portions of the build material, the printing system including two or more susceptors, a first susceptor that causes heating when exposed to microwave radiation at a first temperature and a second susceptor that causes heating when exposed to microwave radiation at a second temperature, wherein the first susceptor material is decomposable or oxidizable at a third temperature that is higher than the second temperature and wherein the second susceptor is transparent to microwave radiation at the first temperature.

2. The printing system of claim 1, wherein the first temperature is room temperature.

3. The printing system of claim 1, wherein the first susceptor is selected from the group consisting of carbon-based materials, semiconductor materials, metal nano particles, and reduced metal oxides.

4. The printing system of claim 3, wherein the carbon-based materials are selected from the group consisting of carbon nanotubes, carbon black, graphite, graphene, fullerenes, silicon carbide, and hydrocarbons containing a polar group, wherein the semiconductor materials are selected from the group consisting of silicon and germanium, wherein the metal nano particles are selected from the group consisting of silver, aluminum, copper, and tin, and wherein the reduced metal oxides are selected from the group consisting of TiOₓ, Fe₃O₄, TaOₓ, NbOₓ, WOₓ, VOₓ, ZrOₓ, HfOₓ MoOₓ, CuOₓ, SnOₓ, ZnOₓ, and CoOₓ, where x is less than a stoichiometric value.

5. The printing system of claim 1 wherein the second susceptor is selected from the group consisting of ceramics, semiconductor oxides, metal oxides, and glasses.

6. The printing system of claim 5 wherein the ceramics are selected from the group consisting of alumina, yttria, silica, silicon nitride, boron nitride, spinel, fluorite, titania, zirconia, and barium titanate, wherein the semiconductor oxides are selected from the group consisting of silica and germania, and wherein the metal oxides are selected from the group consisting of fully oxidized oxides of silver, aluminum, copper, tin, titanium, tantalum, niobium, tungsten, vanadium, hafnium, molybdenum, copper, tin, zinc, and cobalt.

7. The printing system of claim 1, further including a third susceptor that causes microwave heating at room temperature.

8. The printing system of claim 7, wherein the third susceptor is selected from the group consisting of water and low molecular weight organic solvents.

9. The printing system of claim 1, wherein the build material comprises a glass, a ceramic, or a mixture of a glass and a ceramic, one or both of which is the second susceptor.

10. The printing system of claim 1, wherein the ink comprises the first susceptor, a filler, and a liquid vehicle.

11. A method for additively manufacturing a three-dimensional object using the 3D printing system of claim 1, the method including:
providing the build powder;
applying the ink at desired locations in the build powder;
repeating the providing and applying steps a number of times to form the three-dimensional object in the build powder,
heating the three-dimensional object and the build powder with microwave radiation, using the first and second susceptors, to the second temperature to sinter the three-dimensional object; and
heating the three-dimensional object with microwave radiation, using the second susceptor, to the third temperature to either decompose or oxidize the susceptor material.

12. The method of claim 11, wherein the first temperature is a critical temperature of the second susceptor.

13. The method of claim 11, further including providing a third susceptor in the ink that causes heating in microwave radiation at room temperature.

14. The method of claim 11, further including cooling the three-dimensional object to room temperature.

15. A 3D printing system including a build material and an ink for patterning portions of the build material, the printing system including two or more susceptors, a first susceptor in the ink that causes heating in microwave radiation at a first temperature and a second susceptor in the build material that causes heating in microwave radiation at a second temperature, wherein the first susceptor material is decomposable or oxidizable at a third temperature that is higher than the second temperature and wherein the second susceptor is transparent to microwave radiation at the first temperature.
